(19) United States
(12) Patent Application Publication
(10) Pub. No.: US 2007/0058617 A1
(43) Pub. Date: Mar. 15, 2007

(54) Method for establishing and maintaining a connection

(75) Inventors: Martin Stiemerling, Heidelberg (DE); Marcus Brunner, Heidelberg (DE); Saverio Niccolini, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/516,579

(22) Filed: Sep. 7, 2006

(30) Foreign Application Priority Data
Sep. 9, 2005 (DE) 10 2005 043 239.5

(51) Int. Cl. H04L 12/66; H04L 12/56

(52) U.S. Cl. 370/352; 370/401

(57) ABSTRACT

A method for establishing and maintaining a connection between at least one terminal and at least one communication server, preferably for using the connection in case of VolP (Voice over IP) communication, wherein the terminal and the communication server are connected over a network, wherein the establishment and the maintenance of the connection are controlled via a protocol, and wherein parameters of the connection can be adjusted by a configuration is—regarding the configuration that is feasible by an average user—characterized in that the configuration is performed in an automated way, and that configuration information is transmitted in order to configure the connection with messages of the protocol as existing according to the standard specifications.

### BACKGROUND OF THE INVENTION

1. Field of the Invention

The present invention relates to a method for establishing and maintaining a connection between at least one terminal and at least one communication server, preferably in order to use the connection for Voice over IP (VOIP) communication, wherein the terminal and the communication server are interconnected by a network, wherein the establishment and maintenance of the connection are controlled by a protocol, and wherein parameters of the connection can be set by a configuration.

2. Description of the Related Art

Communication over the Internet gains more and more importance. With increasing transmission rates and a better availability of Internet access, the utilization of the Internet is no more restricted to transmitting texts only for quite some time. Real time communication systems like Internet telephony (Voice over IP, VOIP) or video conferencing are gaining more and more importance. In particular, VOIP is not only a matter of interest for companies anymore, but also for regular customers using these technologies at home.

As in the traditional telephone networks, two phases can be basically distinguished for VOIP: the establishment of a call and the transmission of the voice data. The Session Initiation Protocol (SIP) is currently used for the call establishment, and for the transmission of voice the Real Time Protocol (RTP) is most widely used. It is the task of the SIP to create a connection between two or more participants during a communication session. It is not only relevant to find the communication participants in the Internet, but also the corresponding communications paths between the individual participants have to be found. The communication paths comprise the individual servers and nodes that are necessary for the communication. The exact path of an IP data packet cannot be predicted with this, as it is typical for IP data packets.

Problems in case of the establishment of the connection are in particular caused by different components, such as network address translators (NATs) or firewalls, which are required in most of the network structures. Here, corresponding options have to be found in order to enable a secure exchange of VOIP packets and signaling between the participants. In this case, for example, STUN (Simple Traversal of UDP through NATs) servers are used.

In general, at the beginning of a communication session a terminal registers with the communication server that is assigned to the terminal. In case of SIP, for example, the terminal sends a SIP protocol message to the SIP proxy server. If the registration is successful, i.e. in case of valid authentication data, known identifier of the terminal and/or correct further information, the communication server sends a corresponding acknowledgement message back to the terminal. By doing so, the communication server knows for a defined period to which terminal and, if applicable, on which path incoming calls for a specific participant identifier have to be sent. The registration can be performed by an agent, so the user of the terminal is not annoyed by this.

When registering, first of all the communication server is looked up by the user agent of the terminal. For this end, DNS (Domain Name Server) entries, information stored by a DHCP (Dynamic Host Configuration Protocol) server, databases or similar methods can be applied. Thus the protocol messages can be sent to the communication server assigned to the terminal. It may occur that information about a STUN server needs to be used to transmit the protocol messages across a NAT or a firewall. For the transmission of data packets to communication participants, it has to be known in addition, whether the communication participant can be reached only via a firewall and/or a NAT. In such a case corresponding relay servers need possibly to be used when transmitting data.

When setting up a VoIP terminal considerable configuration is required for the safe operation of the connection establishment with SIP, which needs to be done manually. Configuration files need to be adjusted or—at best—the configuration needs to be inserted via a graphic interface. Such works always need to be done when a VOIP device is installed newly or is to be moved from one network environment into another. The configurations contain, for example, the contact data of the SIP proxy server, information about NATs, firewalls, RTP servers or transmission rates. Besides, service - specific configurations, for example information about an available Presence server or a reachable conference server, can be important.

These works on the configuration are cumbersome and very error prone. In addition, such information is usually not known to an average user. In particular when using VOIP terminals in a wireless network, for example a WLAN (Wireless Local Area Network) according to IEEE 802.11, the configuration changes continuously while moving the VOIP terminal around. A manual configuration, as common with VoIP terminals, is not very handy in this context.

### SUMMARY OF THE INVENTION

Hence, the present invention is based on the task to design and further develop a method for establishing and maintaining a connection of the above mentioned kind in such a way that a possibly simple configuration is achieved that can be performed by an average user.

According to the invention, the task mentioned above is solved by a method showing the characteristics of claim 1. According to this, such a method for establishing and maintaining a connection is characterized in that the configuration is performed automatically and that configuration information for the configuration of the connection is transmitted within messages of the protocol as existing according to the standard specifications.

According to the invention, it has first been recognized that an automated configuration can take over the functions of a manual configuration. Furthermore, it has, been recognized that for an automated configuration no additional protocols are needed. In contrast, it is possible to transmit the configuration information necessary to configure a terminal within the messages available as according to the standard specifications. With this configuration information, the connection between a terminal and a communication server assigned to a terminal can be established in order to finally establish a connection with one or more terminals or communication participants, respectively. Hence, the user can be almost completely released from the configuration. In general, the user has to indicate a few basic adjustments, such as authentication information and the communication server used by default. They are valid for a longer time and do not need to be re-adjusted.

The only preconditions for using the method according to the invention are that the terminal already has the correct IP configurations and that the communication server can be found in principle. The IP configuration can either be entered directly into the terminal or can be obtained from a DHCP server or any other arbitrary method known in practice. In order to find the communication server, a DNS server entry, information received from a DHCP server or other methods known in practice can be utilized.

In an advantageous way the above-mentioned protocol messages can be used to perform an automated configuration. In a preferred embodiment of the invention the method according to the invention is applied together with the SIP protocol. The terminal comprises in this case a SIP telephone, and the communication server comprises a SIP proxy server. The method according to the invention can also be used in combination with other protocols. Only to give an example, but not restricting it to this example, it should be referred to the ITU-T standard H.323.

First of all, in an advantageous way the terminal requests the establishment of a connection to a communication server. For this end, the terminal sends a registration message to the communication server, whereby a request for transmission of configuration information to the terminal is transmitted along with the registration message. This request can be realized in the easiest way by implementing an adequate flag in the registration message.

In the same way, in case of already existing connections, an optimization and/or an adjustment of the connection to changed parameters can be necessary. In such a case the terminal could transmit an adequate protocol message to the communication server and requesting up-to-date configuration information by it.

With the request for transmission of configuration information, the terminal could transmit certain basic settings. This could be, for example, information about the location of the terminal, possible maximum data transmission rates, QoS (Quality of Service) information and/or further information. Based on information transmitted in such away, the communication server could gather the configuration information. The configuration information is here completed by information that is known to the communication server and that is necessary for the establishment or the maintenance of the connection, respectively. In total, the configuration information could contain all data that is necessary for a connection between the terminal and the communication server.

The configuration information could then all together be transmitted with an acknowledgement response to the request of the terminal. For this end, the protocol messages available in the applied protocol as according to the standards can be used as acknowledgment of the registration message. For reasons of security, the configuration information can only be sent to the terminal if the registration or the login, respectively, with the communication server was successful. Insofar it makes sense to attach the configuration information only to positive acknowledgement messages, whereas negative acknowledgement messages do not comprise any configuration information.

In particular in case of an optimization and/or adjustment of an already existing connection, but not restricted to this case, configuration information can be amended by additional information which contain an alternative configuration. In such information, for example, the address of one or several possible alternative communication servers, which could be used instead of the used communication server, could be contained. In addition, for the possible alternative communication servers a list of transport protocols and/or port numbers that are preferred or accepted by the respective communication server could be contained in the configuration information.

With such information, for example in case of an overloaded communication server, a connection between terminal and communication server with a high delay or a too bad QoS, or in case of other negative impacts on the connection, an alternative communication server could be chosen and a registration on one of the alternative communication servers could be performed. By such means, the connection between terminal and communication server can continuously be optimized.

At the terminal, the transmitted configuration information is transferred to a configuration of the terminal and the connection to the communication server is adjusted accordingly. In case of alternative configuration information the terminal can choose the corresponding most appropriate configuration information and adjust the configuration of the terminal according to certain policies.

To achieve a complete encapsulation of this establishment of connection and of the negotiation of a usable configuration, the configuration could be performed in an automated way without manual interference of the user by a program running on the terminal. Preferably, an agent will be used to perform this work.

In case a communication server does not react to the request for establishment of a connection, it can be assumed that the communication server is not reachable via the selected way. In the network there could be one or more relay servers available that can be contacted instead of the communication server assigned to terminal. A relay server is—in contrast to common communication servers—preferably reachable over several ports and/or with different transport protocols. By these means, the terminal can choose a relatively arbitrary port and/or a relatively arbitrary transport protocol and can send a corresponding request for registration with the communication server to the relay server. The relay server has information how and in which way the requested communication server can be reached. The relay server could forward the request of the terminal to the communication server, using data known to it of the communication server, regarding selectable ports, accepted transport protocols and/or information regarding the infrastructure in order to reach the communication server. The relay server would then also forward the configuration information of the communication server to the terminal.

If a connection to a communication server can be established, it is in general not ensured that in fact a data transmission is possible between two terminals. Therefore, additional mechanisms are provided, which can test the configuration of an established connection. Preferably, a media test server or another automated device is available in the network with which the configuration of the connection can be tested. In order to test the connection, first of all the terminal or the agent executed at the terminal starts a test call to the media test server and after that a bit pattern is played and sent to the media test server. The terminal and the media test server preferably already know this bit pattern. Hence, by comparing the received and stored bit pattern a first test can be performed to see whether the connection works correctly. Furthermore, the bit pattern can be designed in such a way that it is human understandable.

After the media test server has received the bit pattern correctly and/or compared to the stored bit pattern, the received bit pattern or the stored bit pattern could be sent back to the terminal. By doing so, the terminal could check whether the data was transferred correctly.

Alternatively, the test could be performed not only in an automated way, but it could also be initiated and/or performed directly by a human user. In this case, the user speaks a preferably prescribed message into the terminal and receives a copy of the spoken message back, just as with the automated test. Hence, the user can test the connection himself. If the user receives the voice sequence error-free, the user could inform the media test server about the successful test by a corresponding acknowledgement.

Besides, it is also possible that the test is not triggered by the terminal or its user, but that the media test server initiates a corresponding test. Depending on the intended kind of test, this can make sense.

If a terminal cannot access a media test server by using the set configuration, also in this case a relay server could be used to connect to the media test server. In this case the terminal does not send the request directly to the media test server, but transmits the data to the relay server, which forwards the data accordingly to the media test server by other transport protocol means.

Regarding a possibly easy portability to other terminals, the user of the terminal could be enabled to store basic settings and further information in a user profile as user preferences. These user preferences would then be stored on the communication server, which means that the user can access the preferences from several terminals.

Now, there are several options of how to design and to further develop the teaching of the present invention in an advantageous way. For this purpose, it must be referred to the claims subordinate to claim 1 on the one hand and to the following explanation of a preferred example of an embodiment of the invention together with the figure on the other hand. In connection with the explanation of the preferred example of an embodiment of the invention and the. figure, generally preferred designs and further developments of the teaching will also be explained.

### BRIEF DESCRIPTION OF THE DRAWINGS

FIG. 1 is a diagram showing a signal flow between the terminal and the communication server in an embodiment of the present invention;

FIG. 2 is a diagram showing transmission of the protocol messages over a relay server in the embodiment of the present invention; and

FIG. 3 is a diagram showing a communications when testing a connection in the embodiment of the present invention.

### DESCRIPTION OF THE PREFERRED EMBODIMENT

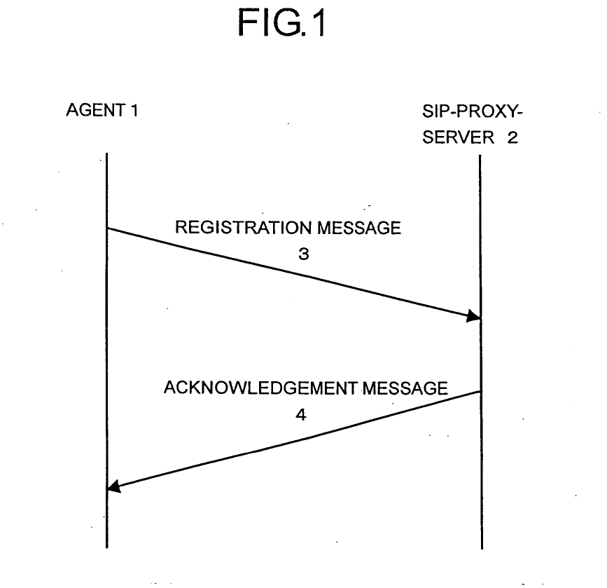

FIG. 1 to 3 refer to the application of the SIP protocol and clarify the processes of signaling with SIP. First of all, FIG. 1 shows schematically how information or messages are exchanged between the terminal or the agent 1 running on the terminal, respectively, and the SIP proxy server 2.

First of all, the agent 1 transmits a registration message “REGISTER”3 to the SIP proxy server 2. Together with this registration message 3 the agent 1 transmits a request to a SIP proxy server 2 to create and transmit configuration information. In addition, the agent sends further information, as for example, authentication data. Furthermore, in the registration message 3 individual user preferences and further wanted settings can be attached. Alternatively, this information can also be stored with the SIP proxy server 2 and after a successful authentication of the terminal, it can be recurred to these user preferences.

Based on the information available to the SIP proxy server 2, the configuration information is created and transmitted to the agent 1. In order to do, in this case an acknowledgement message “200 OK” 4 is transmitted to the agent 1. In case of failed registration, the acknowledgment message “401 UNAUTHORIZED” would be sent back without configuration information.

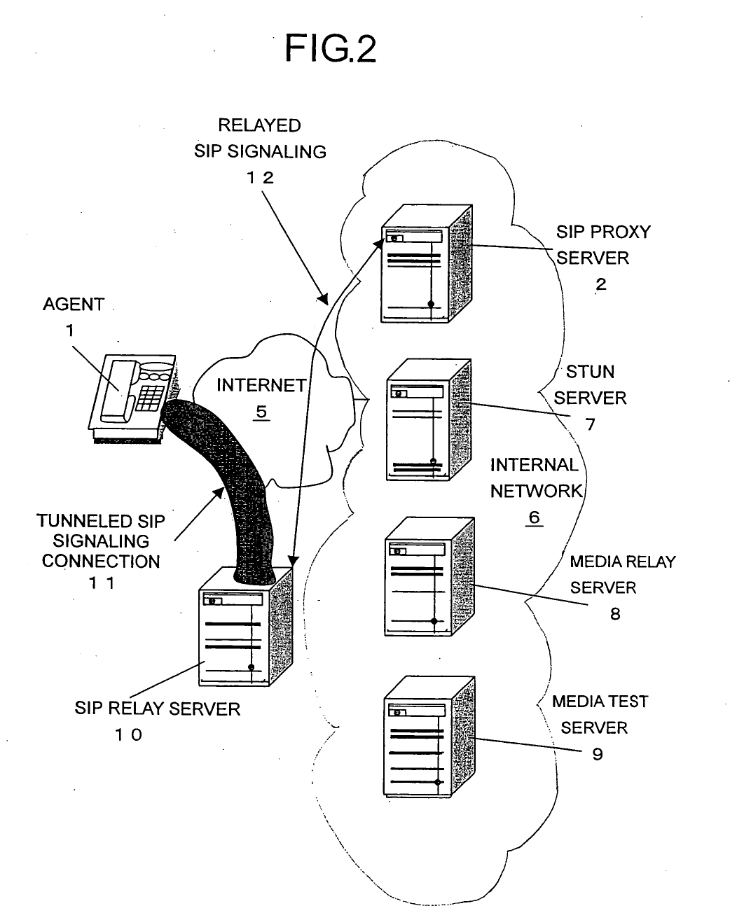

FIG. 2 shows in a schematic depiction the communication between a SIP proxy server 2 and an agent 1 running on the terminal. These two devices are interconnected over the Internet 5 and an internal net 6. The internal net 6 comprises a SIP proxy server 2, as well as a STUN server 7, a media relay server 8 and a media test server 9. If the SIP proxy server 2 cannot be reached directly by the terminal 1, a tunneled SIP signaling connection 11 to a SIP relay server 10 is established. On this path, a registration message is first sent to a SIP relay server 10, which relays the registration message via a transport protocol and corresponding connection data (for example port numbers) accepted by the SIP proxy server 2. The SIP relay server 10 forwards the relayed registration message 12 to the SIP proxy server 2 and establishes on this path a connection between the agent and the SIP proxy server 2.

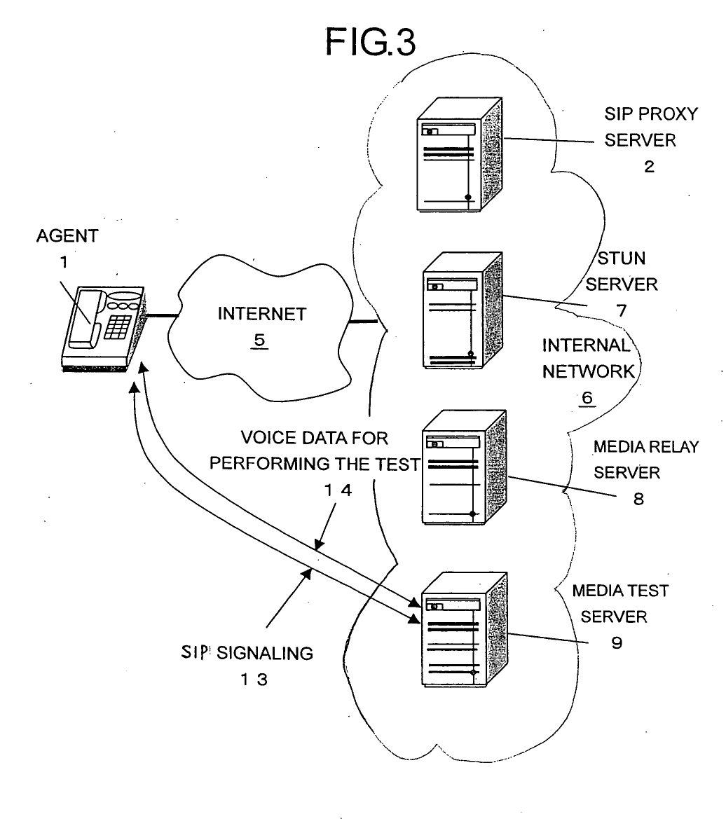

Finally, in FIG. 3 the testing process is depicted in a scheme. It is assumed that a configuration that works in principle is already negotiated between the agent 1 and the SIP proxy server 2, and that a media test server 9 with a connection configured in this way can be reached.

This is ensured if the media test server belongs to the same internal net 6 as the SIP proxy server. With this configuration a connection is now established between the media test server 9 and agent 1, so that voice data for performing a test 14 are exchanged during a test between the agent 1 and the media test server 9. By these means it can be checked whether the negotiated configuration really works.

Finally, it is particularly important to point out that the completely arbitrarily chosen example of an embodiment of the teaching according to the invention from above only serves as illustration of the teaching as according to the invention, but that it does by no means restrict the latter to the given example of an embodiment.

1. A method for establishing and maintaining a connection between at least one terminal and at least one communication server, preferably for using the connection in case of VoIP (Voice over IP) communication, wherein the terminal and the communication server are connected over a network, wherein the establishment and the maintenance of the connection are controlled via a protocol, and wherein parameters of the connection can be adjusted by a configuration, wherein the configuration is performed in an automated way, and that configuration information for the configuration of the connection is transmitted within messages of the protocol as existing according to the standard specifications.

2. The method according to claim 1, where in the protocol comprises the SIP (session initiation protocol) protocol

3. The method according to claim 1, wherein the communication server comprises a SIP proxy server.

4. The method according to claim 1, where in the terminal requests the transmission of configuration information when requesting a connection at the communication server.

5. The method according to claim 1, wherein in case of an already established connection, current configuration information is requested to optimize and adjust the connection to changed parameters.

6. The method according to claim 1, wherein the communication server transmits the configuration information along with the acknowledgment of the request of the terminal.

7. The method according to claim 1, wherein the configuration information is created based on basic settings of the terminal, information about the location of the terminal and/or further information.

8. The method according to claim 1, wherein the configuration information comprise additional information which contain alternative configurations to optimize the connection.

9. The method according to claim 1, wherein the configuration information is transferred to a configuration of the connection by a program running on the terminal.

10. The method according to claim 9, wherein the program executed on the terminal comprises an agent.

11. The method according to claim 1, wherein the request is sent to a relay server in case a communication server cannot be reached.

12. The method according to claim 11, wherein the relay server can be reached at several ports and/or with different transport protocols.

13. The method according to claim 11, wherein the relay server relays the request for data packets with the data that is known at the relay server over the requested communication server regarding the selectable ports, the accepted transport protocols and/or information regarding the infrastructure in order to reach the communication server.

14. The method according to claim 11, wherein the connection to the communication server is established over the relay server.

15. The method according to claim 1, wherein in addition mechanisms are available with which an established connection can be tested.

16. The method according to claim 15, wherein a media test server is available in the network for performing the tests.

17. The method according to claim 15, wherein in case of a failed test the media test server is contacted over another relay server.

18. The method according to claim 1, wherein the configuration is accordingly optimized in case the quality of the connection is not sufficient.

19. The method according to claim 1, wherein the basic settings of the terminal and/or preferences of the user of the terminal are stored on the communication server.
